(19) United States
(12) Patent Application Publication
(10) Pub. No.: US 2017/0137672 A1
(43) Pub. Date: May 18, 2017

(54) Double-Sided Tape

(71) Applicant: PLUS Corporation, Tokyo (JP)

(72) Inventors: Takashi YASUZAWA, Tokyo (JP); Yasuo NARITA, Tokyo (JP); Kosuke HINAGO, Tokyo (JP)

(73) Assignee: PLUS Corporation, Tokyo (JP)

(21) Appl. No.: 15/332,833

(22) Filed: Oct. 24, 2016

(30) Foreign Application Priority Data
Nov. 16, 2015 (JP) 2015-223560

(51) Int. Cl. C09J 7/04; C09J 133/04; C09J 121/00; B32B 7/12; B32B 5/02

(52) U.S. Cl. CPC C09J 7/045; B32B 7/12; B32B 5/022; C09J 121/00; C09J 133/04; B32B 2255/02; B32B 2405/00; C09J 2201/128; C09J 2400/263

(57) ABSTRACT

A double-sided tape having a supporting member; camouflage marking printed on at least one side of the supporting member; and a pressure-sensitive adhesive layer provided on either side of the supporting member.

### BACKGROUND OF THE INVENTION

1. Field of the Invention

The present invention relates to double-sided tapes having a pressure-sensitive adhesive layer on either side of a supporting member.

2. Description of the Related Art

Double-sided tapes, employed for bonding paper to paper, etc., are furnished with a transparent pressure-sensitive adhesive layer on either side of a transparent supporting member. A double-sided tape (Patent Document 1 below) in which product information is printed on the supporting member, and a double-sided tape (Patent Document 2 below) in which advertising or the like is printed on the supporting member (display layer), in order to enhance the facility of conventional such double-sided tapes, are known. The purpose with these is to make it so that through the transparent pressure-sensitive adhesive layers information can be seen by users.

Nevertheless, users who would fix their gaze on the adhesive surface of double-sided tape are extremely few. Hence, despite information being thus printed on the supporting member of a double-sided tape, in many cases that information turns out to be no avail.

### RELATED ART DOCUMENTS

### Patent Documents

Patent Document 1: Japanese Patent Application Publication No. 2004-203938

Patent Document 2: Japanese Patent Application Publication No. 2010-540732

To counter that, a purpose of the present invention is to improve the facility of a double-sided tape. Specifically, it is to make it difficult to discern information noted on, or information connoted by, paper or the like that is adhered utilizing double-sided tape, such that preventing leakage of the information is made possible.

Ordinarily, persons who look intently at an adhered area are third parties who want to see what is written beneath the adhesive surface, not the tape users.

### SUMMARY OF THE INVENTION

A purpose of the present invention is to make available a double-sided tape in which information beneath the pressure-sensitive adhesive surface is guarded from the eyes of such third parties. In order to solve the above challenge, the present invention relates to a double-sided tape having, as described in claim 1: a supporting member; camouflage marking printed on at least one side of the supporting member; and a pressure-sensitive adhesive layer provided on either side of the supporting member.

Additionally, as described in claim2, the supporting member is a nonwoven fabric. Additionally, as described in claim 3, the camouflage marking is randomly arranged alphabetical letters that do not make sense. Additionally, as described in claim 4, the camouflage marking is arranged at an angle to endwise and edgewise orientations of the supporting member.

### BRIEF DESCRIPTION OF THE DRAWINGS

Embodiments will now be described, byway of example only, with reference to the accompanying drawings, which are meant to be exemplary, not limiting, and wherein like elements are numbered alike in several figures, in which:

FIG. 1 is a sectional view of a double-sided tape according to an embodiment of the present invention;

FIG. 2 is a view illustrating camouflage marking to be used in an embodiment of the invention;

FIG. 3 is a view illustrating a tape product using a double-sided tape according to an embodiment of the invention; and

FIG. 4 is a view illustrating a coating film transfer tool using a double-sided tape according to an embodiment of the invention.

### DETAILED DESCRIPTION OF THE INVENTION

The invention will now be described by reference to the preferred embodiments. This does not intend to limit the scope of the present invention, but to exemplify the invention.

Hereinafter, a preferred embodiment for carrying out the present invention will be described in detail with reference to drawings.

### Embodiment

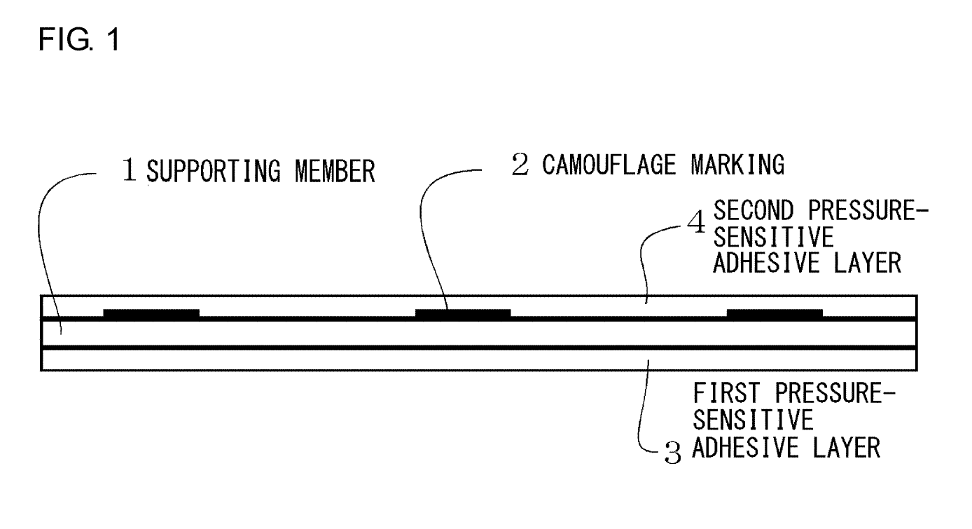

Hereinafter, one embodiment of the present invention will be described with reference to drawings. FIG. 1 is a sectional view of a double-sided tape according to one embodiment of the invention. The reference numeral 1 represents a supporting member that is a nonwoven fabric. The reference numeral 2 represents camouflage marking printed on the upper side of the supporting member 1. The reference numeral 3 represents a first pressure-sensitive adhesive layer formed on the lower side of the supporting member 1, and the reference numeral 4 represents a second pressure-sensitive adhesive layer formed on the upper side of the supporting member 1. Herein, the dimensions of them are arbitrarily changed in accordance with products using this double-sided tape, such as, for example, a sheet product and a roll tape product, or with coating film transfer tools. For example, when a coating film transfer tool is formed, the thickness of the supporting member 1 is set to 25 μm to 35 μm, and the total thickness of the pressure-sensitive adhesive layers including the first pressure-sensitive adhesive layer 3 and the second pressure-sensitive adhesive layer 4 is set to approximately 15 μm to 45 μm. In the case of a product in which the once-adhered tape can be completely peeled, the product is formed, for example, as follows: a resin film is used as the material of the supporting member 1; the thickness of the supporting member is set to 20 μm to 30 μm; and the total thickness of the pressure-sensitive adhesive layers including the first pressure-sensitive adhesive layer 3 and the second pressure-sensitive adhesive layer 4 is set to approximately 45 μm to 65 μm. Herein, the width of the tape is set to 10 mm or 15 mm, but should not be limited thereto.

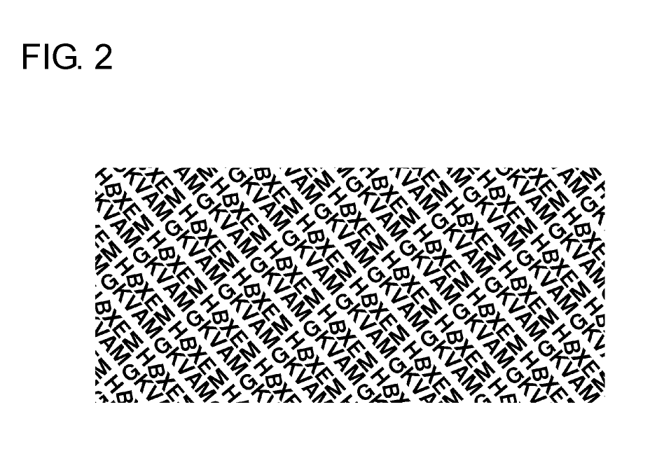

The aforementioned camouflage marking is illustrated in FIG. 2. This camouflage marking has a pattern in which sequences of alphabetical letters that are randomly arranged and do not make sense are continuously arrayed at an angle to endwise and edgewise orientations of the supporting member 1. The respective alphabetical letters are made by using fonts having a fixed width. Additionally, parts of the letters are rotated by 45° and 90° in direction.

In the present embodiment, the sequences of alphabetical letters are printed at an angle on the supporting member 1, and due to being arranged at an angle, it becomes more difficult to discriminate the letter information arranged directly beneath this marking without being arranged at an angle. It also becomes more difficult to discriminate the letter information arranged directly beneath this marking without being arranged at an angle, by using fonts having a fixed width or by changing the direction of part of the letters.

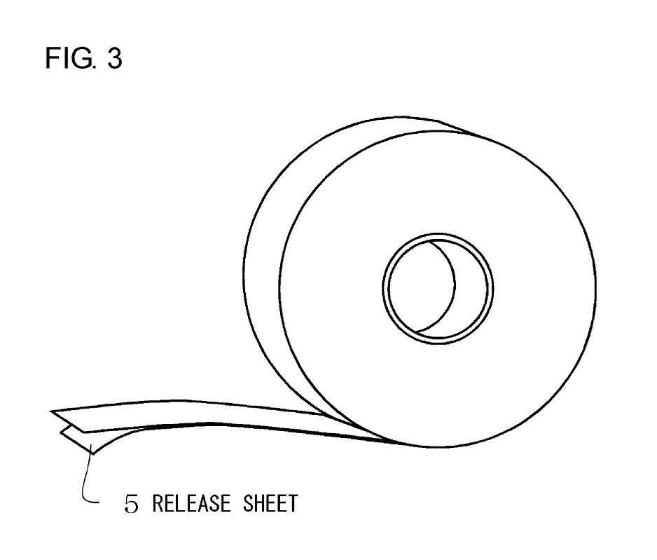

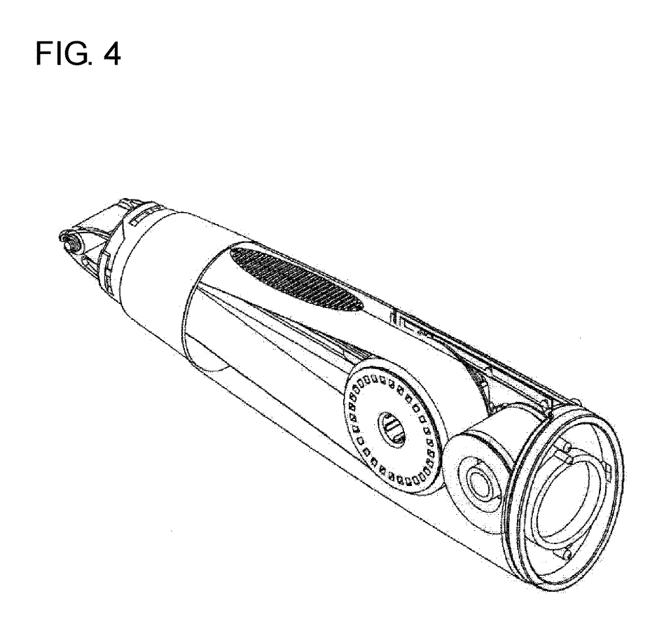

This double-sided tape is formed into a product, for example, by arranging the first pressure-sensitive adhesive layer 3 of the double-sided tape on the upper side of a release sheet 5 and then by winding it into a roll shape, as illustrated in FIG. 3. Additionally, the double-sided tape is used as tape paste of a coating film transfer tool by arranging the first pressure-sensitive adhesive layer on a transparent release tape and then winding it into a roll shape around a reel for supplying the tape paste, as illustrated in FIG. 4. Herein, for the coating film transfer tool, the establishment of a design right has been registered (Japanese Design Registration No. 1392228), but it should not be limited thereto.

In the present embodiment, the supporting member is a nonwoven fabric, but it may be cellulose or a resin film. Additionally, a conventionally used acrylic or rubber pressure-sensitive adhesive is used as the pressure-sensitive adhesive.

The present invention should not be limited to the aforementioned embodiment, and, for example, the camouflage marking may be one in which alphabetical letters are not arranged at an angle. Additionally, random geometric shapes may be adopted instead of alphabetical letters. Additionally, the color of the camouflage marking is not limited to black, and red, blue, or multiple colors may be used.

### INDUSTRIAL APPLICABILITY

The present invention relates to a double-sided tape in which it becomes difficult for third parties to confirm the information arranged directly beneath an area to which the tape has been adhered, and by thus providing a secret-keeping function to the double-sided tape, the facility of the double-sided tape can be enhanced.

1. A double-sided tape comprising:
a supporting member;
camouflage marking printed on at least one side of the supporting member; and
a pressure-sensitive adhesive layer provided on either side of the supporting member.

2. The double-sided tape according to claim 1, wherein
the supporting member is a nonwoven fabric.

3. The double-sided tape according to claim 1, wherein
the camouflage marking is randomly arranged alphabetical letters that do not make sense.

4. The double-sided tape according to claim 3, wherein
the camouflage marking is arranged at an angle to endwise and edgewise orientations of the supporting member.
